(19) United States
(12) Patent Application Publication
(10) Pub. No.: US 2021/0380346 A1
(43) Pub. Date: Dec. 9, 2021

(54) A MOUNTING DEVICE FOR MOUNTING A SCREW FEEDER TO A COMBINATION WEIGHER

(71) Applicant: MAREL A/S, Aarhus N (DK)

(72) Inventors: Ole KAASTRUP, Hinnerup (DK); Anne BROAGER, Egaa (DK)

(21) Appl. No.: 17/285,756

(22) PCT Filed: Oct. 18, 2019
(86) PCT No.: PCT/EP2019/078351

§ 371 Date: Apr. 15, 2021

(30) Foreign Application Priority Data
Oct. 18, 2018 (DK) PA 2018 70682

(51) Int. Cl. B65G 33/32; G01G 19/393

(52) U.S. Cl. CPC B65G 33/32; G01G 19/393

(57) ABSTRACT

A mounting device for mounting a screw feeder to a combination weigher allows an operator to mount a screw feeder to a motor unit assembly of a combination weigher by placing the screw feeder to the motor unit assembly such that the actual rotation of the motor ensures the actual mounting of the screw feeder to the motor unit.

### FIELD OF THE INVENTION

The present invention relates to a mounting device for mounting a screw feeder to a combination weigher.

### BACKGROUND OF THE INVENTION

Combination weighers such as the one shown with position number 100 in FIG. 1 are commonly used today in the food industry to generate portions of food products fulfilling a pre-defined weight target. Such a combination weigher comprises a dispersion unit 101 configured to receive food items from an infeed unit typically positioned above the weigher. A plurality of conveyance units 102 extend radially away from the dispersion units for receiving food items from the dispersion unit. A plurality of weighing hoppers 103 are associated with the conveyance units for receiving food products therefrom. The weighing hoppers are operated by a control unit by repeatedly monitoring the weight in each of the weighing hoppers for finding an optimal weight combination in two or more weighing hoppers such that a target weight is obtained. Subsequently, the food products are dropped from the selected two or more weighing hoppers into a common area, e.g. a bag, tray, or the like.

Such conveyance units consist of trenches and screw feeders 104 arranged therein, where the screw feeders are mechanically attached to motor units and are configured to advance the received food products from an infeed end in the trenches to an outfeed end of the trenches via a rotational movement of the screw feeders 104 and into the associated weighing hoppers.

A common problem today is the mounting process of the screw feeders 104 to the motor units that drive them, where commonly a manual tool is needed to mount and unmount the screw feeders to the motor units. This can be a very tedious and time-consuming process.

### SUMMARY OF THE INVENTION

On the above background it is an object of embodiments of the present invention to provide a simple and a user-friendly mounting device that allows an operator to easily mount a screw feeder to a motor unit or motor unit assembly of a combination weigher by simply placing the screw feeder to the motor unit assembly whereby the actual rotation of the motor ensures the actual mounting of the screw feeder to the motor unit. Similarly, the removal of the screw feeder is greatly facilitated.

In general, the invention preferably seeks to mitigate, alleviate or eliminate one or more of the above-mentioned disadvantages of the prior art singly or in any combination. In particular, it may be seen as an object of embodiments of the present invention to provide a mounting device for a screw feeder that solves the above-mentioned problems, or other problems.

To better address one or more of these concerns, in a first aspect of the invention
a mounting device for mounting a screw feeder to a combination weigher is provided. The mounting device comprises:
a cylindrical mounting end having an outer diameter being essentially the same or less than an inner diameter of a hollow cylindrical shaped receiving cap,
where one of the cylindrical mounting end and the hollow cylindrical shaped receiving cap comprises a first pin structure and the other one of the cylindrical mounting end and the hollow cylindrical shaped receiving cap comprises a first receiving slot and a first longitudinal arranged mounting slot, the first receiving slot extending from a free end along a first longitudinal axes towards a first position, where the first receiving slot is designed for allowing the first pin structure to slide therein and thus the cylindrical mounting end to slide into the hollow cylindrical shaped receiving cap until the first pin structure reaches the first position. The first longitudinal arranged mounting slot has a second longitudinal axis forming an angle in relation to a first longitudinal axis of the first receiving slot,

One of the cylindrical mounting end and the hollow cylindrical shaped receiving cap comprises an attachment end for attachment to a motor unit, whereby during operation of a rotational movement of the motor unit, the first pin structure becomes automatically advanced from the first position and along the first longitudinal arranged mounting slot causing the first pin structure to be propped therein.

Accordingly, a simple solution is provided to mount the screw feeder to the associated combination weigher. Moreover, the removal of the screw feeder from the combination weigher is simple and user friendly.

In one embodiment, the cylindrical mounting end comprises the first pin structure and the hollow cylindrical shaped receiving cap comprises the first receiving slot and the first longitudinal arranged mounting slot. In this embodiment, the first pin structure may extend outwardly from a radial outer surface of the cylindrical mounting end. In an alternative embodiment, the hollow cylindrical shaped receiving cap comprises the first pin structure and the cylindrical mounting end comprises the first receiving slot and the first longitudinal arranged mounting slot. In this embodiment, the first pin structure may extend inwardly from an inner surface of the hollow cylindrical shaped receiving cap.

In one embodiment, the hollow cylindrical shaped receiving cap may comprise the attachment end for attachment to the motor unit and the cylindrical mounting end may be attached to or may form part of the screw feeder. Particularly, the screw feeder may be formed in one part with the cylindrical mounting end, e.g. moulded in one piece.

In an alternative embodiment, the cylindrical mounting end comprises the attachment end for attachment to the motor unit and the hollow cylindrical shaped receiving cap is attached to, or forms part of, the screw feeder.

If the cylindrical mounting end forms part of the screw feeder, the hollow cylindrical shaped receiving cap may be configured to receive the cylindrical mounting end in an axial passage extending through the hollow cylindrical shaped cap between a receiving opening configured to receive the cylindrical mounting end and an axially opposite second opening which is circumferentially enclosed by a spiral shaped like structure. This facilitates easy and thorough cleaning of the spiral shaped structure of the screw feeder. The second opening may have a diameter which is smaller than an inner diameter of the spiral shaped structure measured as the transverse dimension in a projection perpendicular to the longitudinal direction of the screw feeder.

One of the cylindrical mounting end and the hollow cylindrical shaped receiving cap may comprise a second pin structure and the other one of the cylindrical mounting end and the hollow cylindrical shaped receiving cap may comprise a second receiving slot and a second longitudinal arranged mounting slot. The second receiving slot may extend from a free end along a first longitudinal axis towards a second position. The second receiving slot is designed for allowing the second pin structure to slide therein and thus the cylindrical mounting end to slide into the hollow cylindrical shaped receiving cap until the second pin structure reaches the second position.

The second longitudinal arranged mounting slot has a second longitudinal axis forming an angle in relation to a first longitudinal axis of the second receiving slot.

If the first pin structure extends outwardly from the cylindrical mounting end, the second pin structure may preferably also extend outwardly from the cylindrical mounting end, and if the first pin structure extends inwardly from an inner surface of the hollow cylindrical shaped receiving cap, the second pin structure may preferably also extend inwardly from an inner surface of the hollow cylindrical shaped receiving cap.

Alternatively, the first pin structure may be formed on the hollow cylindrical shaped receiving cap where it extends inwardly, and the second pin structure may be formed on the cylindrical mounting end where it extends outwardly. In that embodiment, the first receiving slot and the first longitudinal arranged mounting slot is formed on the cylindrical mounting end, and the second receiving slot and the second longitudinal arranged mounting slot is formed on the hollow cylindrical shaped receiving cap.

In one series of embodiments, each of the longitudinally arranged mounting slots has a meandering shape forming a first pocket in which the first or second pin structures can be received and optionally also a second pocket wherein the first or second pin structures can be received.

The first and optionally the second longitudinal arranged mounting slot define(s) a first section having a component in a forward direction along the first longitudinal axis and a component in the direction of the second longitudinal axis. This defines the first pocket and may provide a locking effect preventing or at least reducing the risk of unintentional disengagement between the cylindrical mounting end and the cylindrical cap.

At least one of the first longitudinal arranged mounting slot and the second longitudinal arranged mounting slot may define a second section, having a component in a rearward direction along the first longitudinal axis and a component in the direction of the second longitudinal axis. This may provide the second pocket and a further locking effect against unintentional disengagement between the cylindrical mounting end and the cylindrical cap.

The first section may be closer to the first receiving slot or second receiving slot than the second section.

Movement of the first or second pin structure into the pockets may be caused e.g. by the counter pressure on the screw feeder when it feeds items. The pin may be moved into the first pocket by counter pressure when rotating the screw feeder in one direction and be moved into the second pocket by counter pressure when rotating the screw feeder in the opposite direction.

In another series of embodiments, the shapes of the pockets are different. In this series of embodiment, the longitudinally arranged mounting slot(s) has an I-profile shape in which the first and optionally the second longitudinal arranged mounting slot defines a first section extending in the direction of the second longitudinal axis, and a second section extending along the first longitudinal axis. The second section may particularly extend transverse to the first section from one side of the first section to an opposite side of the first section, e.g. perpendicular to the direction of the second longitudinal axis, i.e. in the direction of the first longitudinal axis. In this embodiment, the second section forms a first and a second pocket, one on each side of the first section. Movement of the first or second pin structure into one of the pockets may be caused e.g. by the counter pressure on the screw feeder when it feeds items. Rotation of the screw feeder in opposite directions may trigger counter pressure from the food products to press the pin structure into one of either the first or second pockets based on the feeding direction of the food products.

At least one of the first and second pin structures may have a non-circular cross-section, e.g. an elliptical cross-section or a rectangular cross-section, and particularly, it may have an square or rectangular cross section with rounded corners, e.g. rounded with a diameter of 1-10 mm.

The cylindrical mounting end has an outer diameter being essentially the same or less than the inner diameter of a hollow cylindrical shaped receiving cap sufficient for the cylindrical mounting end to be inserted into the hollow cylindrical shaped receiving cap. Preferably, the clearance between the hollow cylindrical shaped receiving cap and the cylindrical mounting end is small since that provides a good bearing strength and the ability to absorb torque transverse to the rotation direction. The clearance may e.g. be less than 3 mm, meaning that the inner diameter of the hollow cylindrical shaped receiving cap is not more than 3 mm larger than the outer diameter of the cylindrical mounting end. The clearance may be less than 1 percent of the diameter of the cylindrical mounting end. This allows the cylindrical mounting end to be carried by the hollow cylindrical shaped receiving cap which thereby absorbs radial forces and moments transverse to the rotation axis. In that way, the screw feeder may be carried alone by a motor via the mounting device.

The small clearance may be established along a certain insertion section along which the cylindrical mounting end is inserted into the hollow cylindrical shaped receiving cap. This insertion section may carry the screw feeder by withstanding radially directed forces. To provide good stability, the insertion section may have a length exceeding a diameter of the cylindrical mounting end. It may e.g. have a length being 2, 3, 4, or 5 times the diameter of the cylindrical mounting end.

In a second aspect of the present invention, a combination weigher is provided comprising a dispersion unit adapted to radially disperse food products dropped in from above and onto the dispersion unit, and a plurality of trenches along and below a periphery of the dispersion unit extending radially away from the dispersion unit, where the trenches comprise receiving ends where the radially dispersed food products are received from the dispersion unit and outfeed ends where the food products are released from the trenches, where each of the trenches is provided with a motor unit, e.g. arranged below the associated trench. The combination weigher comprises multiple of screw feeders associated with each of the trenches, where the combination weigher comprises multiple screw feeders, one associated with each of the trenches, where each of the screw feeders is joined to a motor by a mounting device according to the previous disclosure.

The combination weigher may particularly have a motor structure which can reverse to rotate the connected screw feeder either clockwise or counter-clockwise, and the afore mentioned double pocket structure where the longitudinal arranged mounting slot forms two pockets can be used for securing the screw feeder in any of the two rotation directions.

In general, the various aspects of the invention may be combined within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which:

FIG. 1 shows an example of a prior art combination weigher,

FIGS. 2 to 4, including FIGS. 2(a) to 4(b), show an embodiment of a screw feeder to be used e.g. in relation to a combination weigher shown in FIG. 1,

FIGS. 5-6 illustrate details of pockets of the longitudinal arranged mounting slots;

FIGS. 7-8 illustrate an embodiment where the hollow cylindrical shaped receiving cap forms part of the screw feeder and the cylindrical mounting end comprises an attachment end for attachment to a motor unit;

FIG. 9 illustrates an alternative embodiment, and

FIG. 10 illustrates an alternative embodiment.

### DESCRIPTION OF EMBODIMENTS

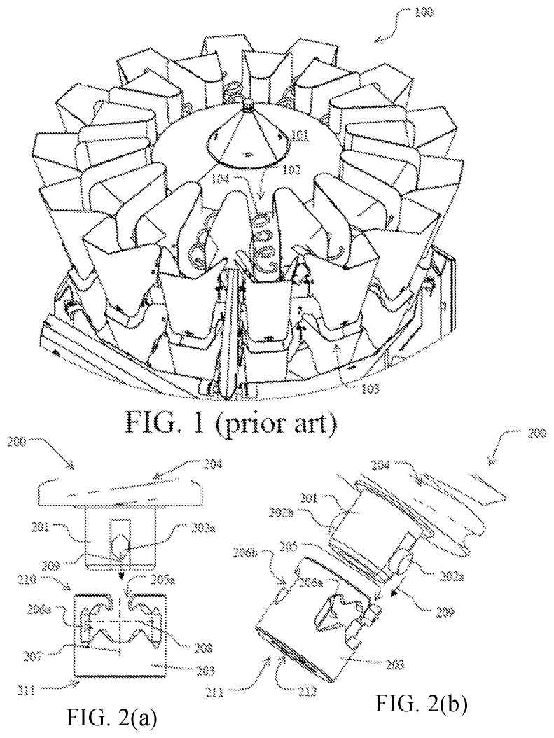

FIGS. 2 to 4 show an embodiment of a screw feeder 200 to be used e.g. in relation to a combination weigher shown in FIG. 1, where the screw feeder comprises a cylindrical mounting end 201 comprising, in this embodiment, two outwardly extending pin structures 202a,b, where at an opposite end of the mounting end is a spiral shaped like structure 204 similar to the spiral shaped structure 104 shown in FIG. 1. The number of outwardly extending pin structures should however not be construed as being limited to two such structures, a single such pin structure may just as well be implemented or more than two.

The outer diameter of the cylindrical mounting end 201 is essentially the same or less than an inner diameter of a hollow cylindrical shaped receiving cap 203. As shown here, the hollow cylindrical shaped receiving cap comprises a free end 210 and an opposite attachment end 211 comprising an engaging structure 212 for mechanically attaching the hollow cylindrical shaped receiving cap to a motor unit (not shown).

The hollow cylindrical shaped receiving cap 203 comprises a first receiving slot 205a and a second receiving slot (not shown here) extending from the free end 210 along a longitudinal axis 207 of the receiving cap towards a first position, where the receiving slots are designed for allowing the outwardly extending pin structures 202a,b to slide therein and thus the cylindrical mounting end to slide into the hollow cylindrical shaped receiving cap.

The cylindrical shaped receiving cap 203 further comprises longitudinal arranged mounting slots 206a,b which second longitudinal axis 208 forms an angle in relation to a first longitudinal axis of the receiving slot, or as shown here, a 90° angle.

FIG. 2 shows the step where the screw feeder is moved (by an operator) as indicated by arrow towards the first/second receiving slots 205a,b.

FIG. 3 depicts where the outwardly extending pin structure 202a (same applies for the pin structure 202b on the opposite site) has reached a first position which may be defined as a bottom position of the first receiving slot 205a,b, i.e. where the mounting end 201 of the screw feeder is resting in the receiving cap 203.

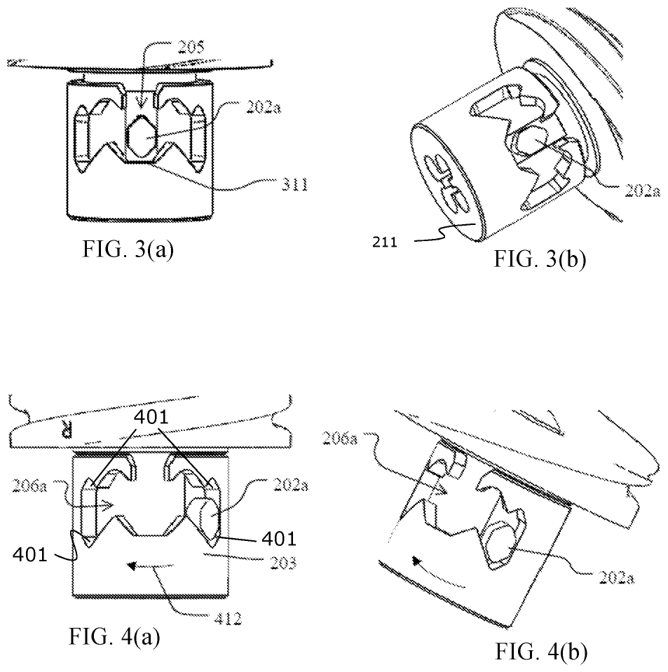

FIG. 4 depicts the scenario where the motor (not shown) is started causing the receiving cap 203 to rotate as indicated by arrow 412 causing the outwardly extending pin structure 202a to automatically move towards an end position of the longitudinal arranged mounting slot 206a until it reaches the end position thereof and becomes automatically propped therein. This embodiment shows two such pin structures, the same occurs for the pin structure 202b on the other side (not shown) in the mounting slot 206b. Accordingly, an operator only needs to push the screw feeder 200 into the first receiving slot 205a,b where the respective pin structures slide through the respective slots 205a,b, where after subsequent starting of the motor, the screw feeder becomes automatically fixed to the receiving cap as shown in FIG. 4(b).

In the embodiment of FIGS. 2-4, the first and second longitudinal arranged mounting slots 206a,b define pockets 401, c.f. FIG. 4. The pockets are configured to receive the first and second pin structures 202a, b.

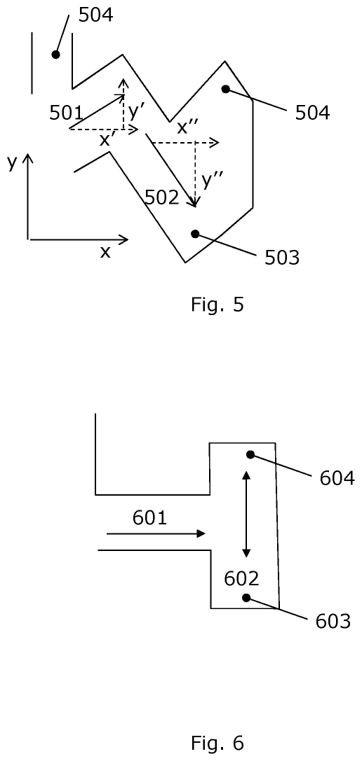

The pockets are shown in the schematic view of FIG. 5 and are defined by use of the illustrated Cartesian space. The first section extends along the arrow 501 and has a component y′ in a forward direction along the first longitudinal axis 207, i.e. a component in the Y direction of the illustrated Cartesian space. It also has a component x′ in the direction of the second longitudinal axis (208), i.e. a component in the X direction of the illustrated Cartesian space.

The second section extends along the arrow 502 and has a component in the direction of the second longitudinal axis 208, i.e. the component x″, and a component in a rearward direction which is opposite the forward direction along the first longitudinal axis 207, i.e. the component y″. This forms pockets at the location illustrated by the dots 503, 504 in which the first or second pin structure can be received.

The first section illustrated by arrow 501 is closer to the first receiving slot 205 (or to the second receiving slot) than the second section illustrated by arrow 502.

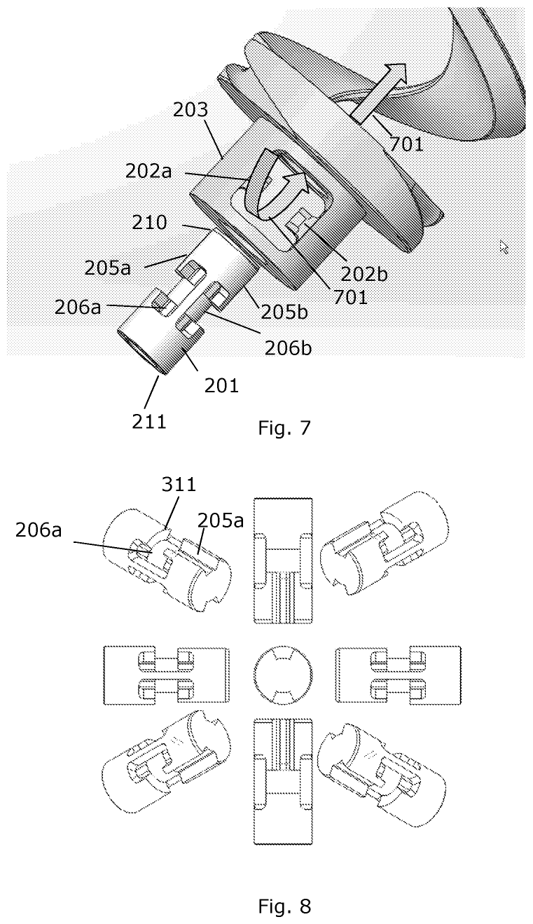

FIGS. 7 and 8 illustrate an embodiment where the hollow cylindrical shaped receiving cap forms part of the screw feeder, and the attachment end 211 is part of the cylindrical mounting end.

The hollow cylindrical shaped receiving cap defines a passage which is sized to receive the cylindrical mounting end. The passage extends axially between a receiving opening where the cylindrical mounting end is to be inserted and an axially opposite second opening pointing into the screw thread structure of the screw feeder. The axial passage is indicated by the arrow 701.

In the embodiment of FIGS. 7 and 8, the hollow cylindrical shaped receiving cap comprises a first and a second inwardly extending pin structure 202a, b which are received in the first and second receiving slot 205a,b.

FIG. 6 illustrates schematically the first longitudinal arranged mounting slot 206a or the second longitudinal arranged mounting slot 206b in the embodiment of FIGS. 7 and 8.

In this embodiment, the longitudinal arranged mounting slot defines a first section extending in the direction of the second longitudinal axis 208, illustrated in FIG. 6 with the arrow 601, and a second section extending along the first longitudinal axis 207, illustrated in FIG. 6 with the arrow 602. The second section extends transverse to the first section from one side of the first section to an opposite side of the first section. This forms pockets at the location illustrated by the dots 603, 604 in which the first or second pin structure can be received.

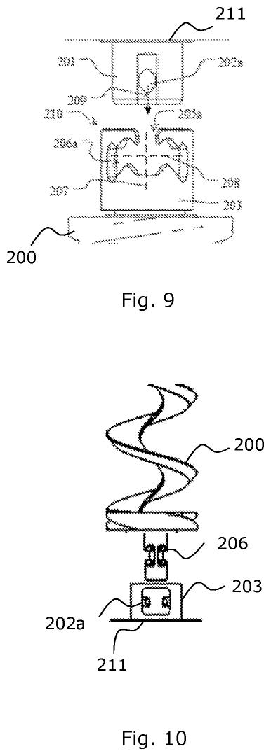

FIG. 9 illustrates an embodiment where the cylindrical mounting end 201 comprises the first pin structure 202a, and the hollow cylindrical shaped receiving cap 203 comprises the first receiving slot 205a and the first longitudinal arranged mounting slot 206a. In this embodiment, the hollow cylindrical shaped receiving cap forms part of the screw feeder 200 and the cylindrical mounting end 201 comprises the attachment end 211 for attachment to a motor unit.

FIG. 10 illustrates an embodiment where the hollow cylindrical shaped receiving cap 203 comprises the first pin structure 202a and the cylindrical mounting end comprises the first receiving slot and the first longitudinal arranged mounting slot 206a. In this embodiment, the cylindrical mounting end forms part of the screw feeder 200 and the hollow cylindrical shaped receiving cap 203 comprises the attachment end 211 for attachment to a motor unit.

In the embodiments illustrated in FIGS. 2-4 and 7-8 the first and second pin structures 202a,b are formed on that one of the hollow cylindrical shaped receiving cap 203 or cylindrical mounting end 201 which forms part of the screw feeder 200. In the embodiments illustrated in FIGS. 9-10, the pin structures 202a,b are formed on that one of the hollow cylindrical shaped receiving cap 203 or cylindrical mounting end 201 which forms the attachment end 211 for attachment of the motor unit.

The embodiment corresponding to FIGS. 2-4 and 7-8 may be preferred, particularly since the pin structures are formed in one part with the screw feeder. During attachment of the screw feeder to the motor unit, it may be an advantage to manipulate the screw feeder with the pin structure.

### Numbered Further Embodiments

1. A mounting device for mounting a screw feeder (200) to a combination weigher, comprising:
a cylindrical mounting end (201) comprising a first outwardly extending pin structure (202a), where the outer diameter of the cylindrical mounting end is essentially the same or less than an inner diameter of a hollow cylindrical shaped receiving cap (203), where the hollow cylindrical shaped receiving cap comprises a free end (210) and an opposite mounting end (211) for mechanically mounting the hollow cylindrical shaped receiving cap to a motor unit,
where the hollow cylindrical shaped receiving cap comprises a first receiving slot (205a) extending from the free end along a longitudinal axes of the receiving cap towards a first position (311), where the first receiving slot is designed for allowing the first outwardly extending pin structure (202a) to slide therein and thus the cylindrical mounting end (201) to slide into the hollow cylindrical shaped receiving cap (203) until the first outwardly extending pin structure (202a) reaches the first position, where the cylindrical shaped receiving cap further comprises a first longitudinal arranged mounting slot (206a) which second longitudinal axis (208) forms an angle in relation to a first longitudinal axis (207) of the first receiving slot,
whereby during operation of a rotational movement of the motor unit and thus the hollow cylindrical shaped receiving cap, the first outwardly extending pin structure becomes automatically advances from the first position and along the first longitudinal arranged mounting slot causing the first outwardly extending pin structure to be propped therein.

2. The screw feeder according to embodiment 1, wherein the cylindrical mounting end further comprises a second outwardly extending pin structure, and where the hollow cylindrical shaped receiving cap further comprises a second receiving slot and a second longitudinal arranged mounting slot designed in essentially the same manner as said first receiving slot and said first longitudinal arranged mounting slot, where the second receiving slot and the second longitudinal arranged mounting slot are designed to engage with the second outwardly extending pin structure in essentially the same manner as said first receiving slot and the first longitudinal arranged mounting slot engage with said first outwardly extending pin structure.

3. A combination weigher comprising a dispersion unit adapted to radially disperse food products dropped in from above and onto the dispersion unit, and a plurality of trenches along and below a periphery of the dispersion unit extending radially away from the dispersion unit, where the trenches comprise receiving ends where the radially disperse food products are received from the dispersion unit and outfeed ends where the food products are released from the trenches, where each of the trenches is provided with a motor unit arranged below the associated trench having a hollow cylindrical shaped receiving cap having a free end and an opposite mounting end for mechanically mounting the hollow cylindrical shaped receiving cap to the motor unit, where the combination weigher comprises multiple of screw feeders associated with each of the trenches, where each of the screw feeders comprises a mounting device which comprises:
a cylindrical mounting end having a first outwardly extending pin structure, where the outer diameter of the cylindrical mounting end is essentially the same or less than the inner diameter of the hollow cylindrical shaped receiving cap, where the hollow cylindrical shaped receiving cap comprises a first receiving slot extending from the free end thereof and along a longitudinal axes of the receiving cap towards a first position, where the first receiving slot is designed for allowing the first outwardly extending pin structure to slide therein and thus the cylindrical mounting end to slide into the hollow cylindrical shaped receiving cap, where the cylindrical shaped receiving cap further comprises a first longitudinal arranged mounting slot which second longitudinal axis forms an angle in relation to a first longitudinal axis of the first receiving slot,
whereby during operation of a rotational movement of the motor unit and thus the hollow cylindrical shaped receiving cap, the first outwardly extending pin structure becomes automatically advances from the first position and along the first longitudinal arranged mounting slot causing the first outwardly extending pin structure to be propped therein.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1.-19. (canceled)

20. A mounting device for mounting a screw feeder to a combination weigher, comprising:
a cylindrical mounting end having an outer diameter being essentially the same or less than an inner diameter of a hollow cylindrical shaped receiving cap,
where one of the cylindrical mounting end and the hollow cylindrical shaped receiving cap comprises a first pin structure and the other one of the cylindrical mounting end and the hollow cylindrical shaped receiving cap comprises a first receiving slot and a first longitudinal arranged mounting slot, the first receiving slot extending from a free end along a first longitudinal axis towards a first position, where the first receiving slot is designed for allowing the first pin structure to slide therein when the cylindrical mounting end slides into the hollow cylindrical shaped receiving cap until the first pin structure reaches the first position, the first longitudinal arranged mounting slot having a second longitudinal axis forming an angle in relation to the first longitudinal axis of the first receiving slot,
where one of the cylindrical mounting end and the hollow cylindrical shaped receiving cap comprises an attachment end for attachment to a motor unit, whereby during operation of a rotational movement of the motor unit, the first pin structure becomes automatically advanced from the first position and along the first longitudinal arranged mounting slot causing the first pin structure to be propped therein.

21. The mounting device according to claim 20, where the cylindrical mounting end comprises the first pin structure and the hollow cylindrical shaped receiving cap comprises the first receiving slot and the first longitudinal arranged mounting slot.

22. The mounting device according to claim 20, where the hollow cylindrical shaped receiving cap comprises the first pin structure and the cylindrical mounting end comprises the first receiving slot and the first longitudinal arranged mounting slot.

23. The mounting device according to claim 20, where the hollow cylindrical shaped receiving cap comprises the attachment end for attachment to the motor unit.

24. The mounting device according to claim 23, wherein the cylindrical mounting end forms part of the screw feeder.

25. The mounting device according to claim 20, where the cylindrical mounting end comprises the attachment end for attachment to the motor unit.

26. The mounting device according to claim 25, wherein the hollow cylindrical shaped receiving cap forms part of the screw feeder.

27. The mounting device according to claim 26, wherein the hollow cylindrical shaped cap is configured to receive the cylindrical mounting end in an axial passage extending through the hollow cylindrical shaped cap between a receiving opening configured to receive the cylindrical mounting end and an axially opposite second opening which is circumferentially enclosed by a spiral shaped structure.

28. The mounting device according to claim 20, wherein one of the cylindrical mounting end and the hollow cylindrical shaped receiving cap comprises a second pin structure and the other one of the cylindrical mounting end and the hollow cylindrical shaped receiving cap comprises a second receiving slot and a second longitudinal arranged mounting slot, the second receiving slot extending from a free end along a longitudinal axis towards a second position, where the second receiving slot is designed for allowing the second pin structure to slide therein and thus the cylindrical mounting end to slide into the hollow cylindrical shaped receiving cap until the second pin structure reaches the second position, the second longitudinal arranged mounting slot having a second longitudinal axis forming an angle in relation to a first longitudinal axis of the second receiving slot,
wherein during operation of a rotational movement of the motor unit, the second pin structure becomes automatically advanced from the second position and along the second longitudinal arranged mounting slot causing the second pin structure to be propped therein.

29. The mounting device according to claim 28, wherein the first pin structure and the second pin structure are formed on the same hollow cylindrical shaped receiving cap or cylindrical mounting end.

30. The mounting device according to claim 20, wherein the first pin structure is formed on the hollow cylindrical shaped receiving cap, and the second pin structure is formed on the cylindrical mounting end.

31. The mounting device of claim 20, wherein at least one of the first longitudinal arranged mounting slot and second longitudinal arranged mounting slot defines a first section, having a component in a forward direction along the first longitudinal axis and a component along the second longitudinal axis.

32. The mounting device of claim 31, wherein at least one of the first longitudinal arranged mounting slot and the second longitudinal arranged mounting slot defines a second section, having a component along the second longitudinal axis and a component in a rearward direction which is opposite the forward direction along the first longitudinal axis thereby forming a pocket in which the first or second pin structure can be received.

33. The mounting device of claim 30, wherein the first section is closer to the first receiving slot or second receiving slot than the second section.

34. The mounting device according to claim 20, wherein at least one of the first longitudinal arranged mounting slot and second longitudinal arranged mounting slot defines a first section extending in the direction of the second longitudinal axis, and a second section extending along the first longitudinal axis.

35. The mounting device according to claim 34, wherein the second section extends transverse to the first section from one side of the first section to an opposite side of the first section.

36. The mounting device of claim 20, wherein at least one of the first and second pin structure has a non-circular cross-section.

37. The mounting device according to claim 20, wherein the cylindrical mounting end has the outer diameter being essentially the same or less than the inner diameter of a hollow cylindrical shaped receiving cap over an insertion section having a length exceeding a diameter of the cylindrical mounting end.

38. A combination weigher comprising a dispersion unit adapted to radially disperse food products dropped in from above and onto the dispersion unit, and a plurality of trenches along and below a periphery of the dispersion unit extending radially away from the dispersion unit, where the trenches comprise receiving ends where the radially disperse food products are received from the dispersion unit and outfeed ends where the food products are released from the trenches, where each of the trenches is provided with a motor unit arranged below the associated trench, where the combination weigher comprises multiple of screw feeders associated with each of the trenches, where each of the screw feeders is joined to a motor by a mounting device according claim 20.
